(19) United States
(12) Patent Application Publication
(10) Pub. No.: US 2019/0152284 A1
(43) Pub. Date: May 23, 2019

(54) VEHICLE SUSPENSION STRUCTURE WITH TUNED VIBRATION ABSORBER

(71) Applicant: GM Global Technology Operations LLC, Detroit, MI (US)

(72) Inventors: Robert P. Marble, White Lake, MI (US); Christopher A. Stirlen, Milford, MI (US); Michael E. McGuire, Milford, MI (US)

(21) Appl. No.: 15/818,945

(22) Filed: Nov. 21, 2017

(51) Int. Cl. B60G 13/16; B60G 13/00

(52) U.S. Cl. CPC B60G 13/16; B60G 2202/25; B60G 2600/44; B60G 13/005

(57) ABSTRACT

A vehicle suspension structure includes a hollow structural component and a Tuned Vibration Absorber disposed inside the hollow structural component.

### INTRODUCTION

The subject disclosure relates to vehicle suspension structure, and more particularly, to a vehicle suspension structure including a Tuned Vibration Absorber (TVA).

Vehicle suspension systems are constructed to permit relative motion between a vehicle frame and vehicle wheels. In certain applications, the suspension system ideally maintains wheel contact with terrain surfaces (e.g., road surfaces) over which the vehicle is traveling. While attempting to maintain such contact, undesired vibrations may be transmitted through various components of the suspension system.

Accordingly, it is desirable that a vehicle suspension structure is capable of absorbing, or otherwise reducing such undesired vibrations.

### SUMMARY

A vehicle suspension structure according to one, non-limiting, embodiment of the present disclosure includes a hollow structural component, and a Tuned Vibration Absorber (TVA) disposed inside the hollow structural component.

Additionally to the foregoing embodiment, the hollow structural component is a control arm.

In the alternative or additionally thereto, in the foregoing embodiment, the vehicle suspension structure includes an upper control arm, wherein the hollow structural component is a lower control arm.

In the alternative or additionally thereto, in the foregoing embodiment, the TVA includes a first shuttling mass and a first vibration manipulator adapted to act upon the first mass.

In the alternative or additionally thereto, in the foregoing embodiment, the first vibration manipulator includes a first spring element, and a first damper element.

In the alternative or additionally thereto, in the foregoing embodiment, the first vibration manipulator is a first resiliently compressible member.

In the alternative or additionally thereto, in the foregoing embodiment, the TVA includes a second vibration manipulator located opposite the first shuttling mass from the first vibration manipulator and adapted to act upon the first shuttling mass.

In the alternative or additionally thereto, in the foregoing embodiment, the first and second vibration manipulators each include a spring element and a damper element.

In the alternative or additionally thereto, in the foregoing embodiment, the first and second vibration manipulators are respective unitary and resiliently compressible first and second members.

In the alternative or additionally thereto, in the foregoing embodiment, the first and second members are rubber-like.

In the alternative or additionally thereto, in the foregoing embodiment, the TVA includes a third vibration manipulator, a partition disposed between the second and third vibration manipulators, a fourth vibration manipulator, and a second shuttling mass disposed between the third and fourth vibration manipulators, and wherein the third and fourth vibration manipulators are adapted to act upon the second shuttling mass.

In the alternative or additionally thereto, in the foregoing embodiment, the partition is fixed to the hollow structural component.

In the alternative or additionally thereto, in the foregoing embodiment, the partition is adapted to slide within the hollow structural component.

In the alternative or additionally thereto, in the foregoing embodiment, the first shuttling mass includes a friction reducing coating.

In the alternative or additionally thereto, in the foregoing embodiment, the TVA includes a third vibration manipulator, a fourth vibration manipulator and a second shuttling mass disposed between the third and fourth vibration manipulators, and wherein the second shuttling mass is disposed parallel to the first shuttling mass.

A lower control arm of another, non-limiting, embodiment is part of a vehicle suspension structure that defines an internal cavity extending along a centerline. The lower control arm includes a Tuned Vibration Absorber (TVA) disposed in the cavity.

Additionally to the foregoing embodiment, the TVA includes a first vibration manipulator, a second vibration manipulator, and a shuttling mass disposed axially between the first and second vibration manipulators.

In the alternative or additionally thereto, in the foregoing embodiment, the first and second vibration manipulators are made of a resiliently compressible rubber-like material.

In the alternative or additionally thereto, in the foregoing embodiment, the resiliently compressible rubber-like material is high temperature silicone.

In the alternative or additionally thereto, in the foregoing embodiment, the shuttling mass is encased in the resiliently compressible rubber-like material of the first and second vibration manipulators.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a perspective view of a suspension structure of a vehicle utilizing a Tuned Vibration Absorber (TVA) as one exemplary embodiment;

FIG. 2 is a schematic diagram of a cross section of a hollow structural component of the suspension structure utilizing the TVA;

FIG. 3 is a cross section of the hollow structural component illustrating resiliently compressible members of the TVA;

FIG. 4 is a partial cross section of a shuttling mass of the TVA; and

FIG. 5 is a cross section of a second embodiment of the TVA similar in perspective to FIG. 2.

### DETAILED DESCRIPTION

The following description is merely exemplary in nature and is not intended to limit the present disclosure, its application or uses. It should be understood that throughout the drawings, corresponding reference numerals indicate like or corresponding parts and features.

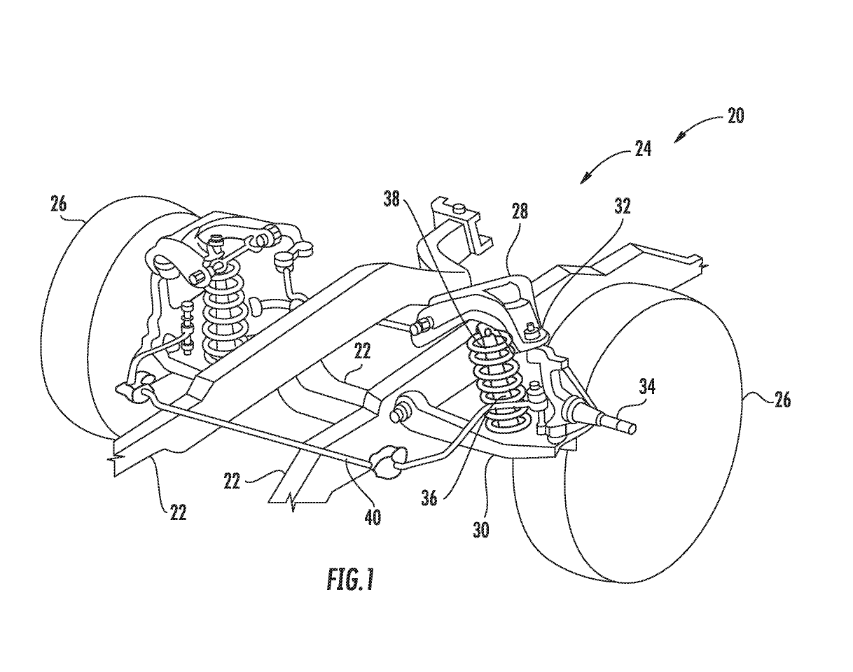

In accordance with an exemplary embodiment a vehicle 20, as illustrated in FIG. 1, may include a vehicle frame 22, a suspension structure 24, and wheels 26 (i.e., tires). The suspension structure 24 may be structurally supported by the vehicle frame 22, and the wheels 26 may be rotationally supported by the suspension structure 24. The suspension structure 24 is constructed to allow relative motion between the wheels 26 and the vehicle frame 22.

As known by one skilled in the art of vehicle suspensions, the suspension structure(s) 24 may be proximate to each wheel 26, and may include an upper control arm 28, a lower control arm 30, an upper ball joint 32, a spindle 34, a shock absorber 36, a coil spring 38, and many other associated components including a stabilizer bar 40. In many applications, the various suspension elements and/or components may be hollow to minimize weight while maintaining the desired structural integrity. The suspension structure 24 may be any one of a variety of suspension types including front, or steerable, steering type suspensions, rear suspensions, suspensions with leaf springs, independent suspensions, double wishbone suspensions, swing axle suspensions, solid beam axle suspension, trailing link suspension, MacPherson suspensions, and others.

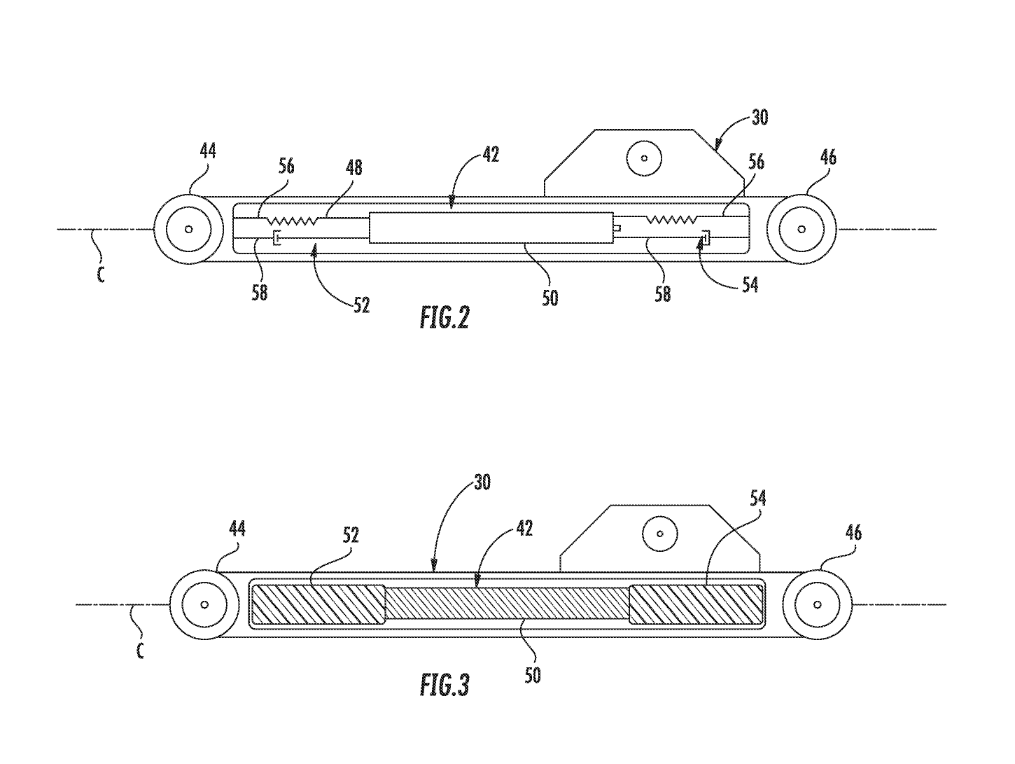

Referring to FIG. 2, the suspension structure 24 further includes at least one Tuned Vibration Absorber (TVA) 42 configured to dampen and/or reduce vibration and noise caused by suspension generated noises, tire flexural modes, tire cavity noises, rough road harshness, and other conditions. The TVA 42 may be generally located in any of the hollow, structural, suspension components that may be elongated, lateral, linkages. One such elongated, lateral, linkage may be the lower control arm 30.

The lateral linkage, or lower control arm 30, may extend along a centerline C, and may include a first end portion 44 pivotally engaged to the vehicle frame 22 and a second end portion 46 pivotally engaged to an one of a variety of adjacent suspension components (not shown). In the present embodiment, the lower control arm 30 may include boundaries that define a cavity 48, which may be elongated and longitudinally extends along the centerline C. It is contemplated and understood that the lateral linkage may alternatively, or in addition to, be the upper control arm 28.

The TVA 42 is supported by the lower control arm 30, is located in the cavity 48, and may include a shuttling mass 50, a first vibration manipulator 52, and a second vibration manipulator 54. The first vibration manipulator 52 may be axially disposed between the first end portion 44 of the lower control arm 30 and the shuttling mass 50. The shuttling mass 50 may be axially disposed between the first vibration manipulator 52 and the second vibration manipulator 54. The second vibration manipulator 54 may be axially disposed between the shuttling mass 50 and the second end portion 46 of the lower control arm 30.

The vibration manipulators 52, 54 may each include a spring element 56 and a damper element 58 having respective spring and damping characteristics. In one embodiment, the spring element 56 may be a coiled spring, and the damper element 58 may be a hydraulic apparatus with orifices to restrict fluid flow. As best shown in FIG. 3, the vibration manipulators 52, 54 may each be a resiliently compressible member that performs the function of both the spring element 56 and the damper element 58. In one embodiment, the members or manipulators 52, 54 may be rubber-like, may be a high temperature silicone, and/or may be a silicone rubber. The shuttling mass 50 may be metallic (e.g., brass), and may be embedded in the silicone rubber. It is contemplated and understood that one or more of the vibration manipulators 52, 54 may only consist of the spring element 56 depending upon the desired vibration reducing or damping characteristics. The term “rubber-like” is meant to include any material that is resiliently compressible.

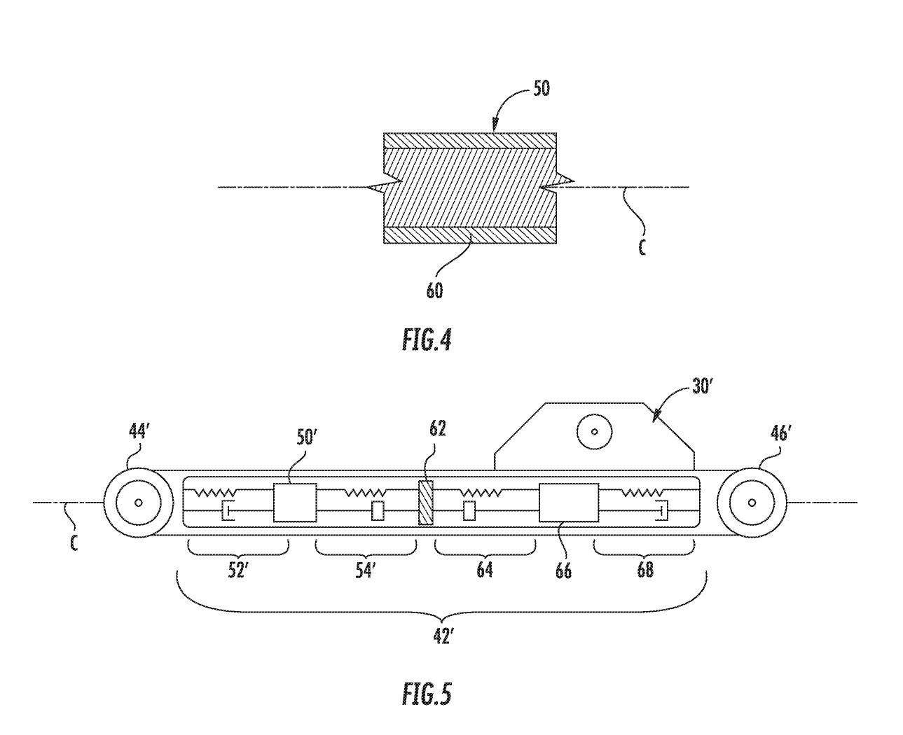

Referring to FIG. 4, the shuttling mass 50 may include a coating 60 that reduces friction between the lower control arm 30 and the mass 50 as the mass 50 moves axially along the centerline C. In one embodiment, the coating 60 may be a polytetrafluoroethylene (PTFE), or similar material, depending on the makeup of the hollow lower control arm 30, the shuttling mass 50, and on the coefficient of friction there-between.

The shuttling mass 50 may be solid, or may include holes or cavities to fine tune the amount of mass or weight in the TVA 42. Alternatively, tuning of the mass 50 may be achieved by varying the size of the mass 50, or by varying the density of the metallic composition of the mass, such that the actual weight is altered within the same relative volume. The shuttling mass 50 may be shaped to substantially match the cross section of the arm cavity 48 to reduce any lateral motion of the mass within the cavity that may cause undesired rattle. In one example, the weight of the shuttling mass 50 may be greater than about 0.25 kilograms.

In operation, the vibration manipulators 52, 54 are constructed to store energy and damp axial movement of the shuttling mass 50 along the centerline C (i.e., longitudinal length of the lower control arm 30). The shuttling motion of the mass 50 is fine tuned in amplitude and frequency to cancel out undesired vibrations caused by operation of the vehicle 20 and associated with the lower control arm 30. That is, the TVA 42 is constructed to absorb, in whole or in part, vibrations passing through the lower control arm 30 between the pivoting end portions 44, 46.

Referring to FIG. 5, a second embodiment of the TVA is illustrated wherein like elements to the first embodiment have the same element numbers except with the addition of a prime symbol suffix. The TVA 42′ (i.e., compound TVA) may include a first shuttling mass 50′, a first vibration manipulator 52′, a second vibration manipulator 54′ a partition 62, a third vibration manipulator 64, a second shuttling mass 66, and a fourth vibration manipulator 68. The shuttling masses 50′, 66 may be orientated in series with respect to centerline C. That is, the first vibration manipulator 52′ may be axially disposed between a first end portion 44′ of the lower control arm 30′ and the first shuttling mass 50′. The first shuttling mass 50′ may be axially disposed between the first vibration manipulator 52′ and the second vibration manipulator 54′. The second vibration manipulator 54′ may be axially disposed between the first shuttling mass 50′ and the partition 62. The partition 62 may be fixed to the lower control arm 30′, and may be axially disposed between the second vibration manipulator 54′ and the third vibration manipulator 64. The third vibration manipulator 64 may be axially disposed between the partition 62 and the second shuttling mass 66. The second shuttling mass 66 may be axially disposed between the third vibration manipulator 64 and the fourth vibration manipulator 68. The fourth vibration manipulator 68 may be axially disposed between the second shuttling mass 66 and a second end portion 46′ of the lower control arm 30′. In another embodiment, the partition 62 may be adapted to slide within the control arm 30′. It is further contemplated and understood that the shuttling masses 50′, 66 may be orientated in parallel with the vibration manipulators 52′, 54′, 64, 68 appropriately configured and each mass 50′, 66 adapted to move along respective centerlines.

In operation, the TVA 42′ may function as two independent TVA's, each being fine-tuned to reduce or eliminate respective ranges of harmonic vibrations passing through the lower control arm 30′. The source of such undesired vibrations may be caused, for example, by washboard road surfaces.

Advantages and benefits of the present disclosure include the ability to minimize, or eliminate, undesired noise close to the source with minimal impact on suspension structure packaging.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle suspension structure comprising:
a hollow structural component; and
a Tuned Vibration Absorber (TVA) disposed inside the hollow structural component.

2. The vehicle suspension structure set forth in claim 1, wherein the hollow structural component is a control arm.

3. The vehicle suspension structure set forth in claim 1, further comprising:
an upper control arm, wherein the hollow structural component is a lower control arm.

4. The vehicle suspension structure set forth in claim 1, wherein the TVA includes a first shuttling mass and a first vibration manipulator adapted to act upon the first mass.

5. The vehicle suspension structure set forth in claim 4, wherein the first vibration manipulator includes a first spring element, and a first damper element.

6. The vehicle suspension structure set forth in claim 4, wherein the first vibration manipulator is a first resiliently compressible member.

7. The vehicle suspension structure set forth in claim 4, wherein the TVA includes a second vibration manipulator located opposite the first shuttling mass from the first vibration manipulator and adapted to act upon the first shuttling mass.

8. The vehicle suspension structure set forth in claim 7, wherein the first and second vibration manipulators each include a spring element and a damper element.

9. The vehicle suspension structure set forth in claim 7, wherein the first and second vibration manipulators are respective unitary and resiliently compressible first and second members.

10. The vehicle suspension structure set forth in claim 7 wherein the first and second members are rubber-like.

11. The vehicle suspension structure set forth in claim 7, wherein the TVA includes a third vibration manipulator, a partition disposed between the second and third vibration manipulators, a fourth vibration manipulator, and a second shuttling mass disposed between the third and fourth vibration manipulators, and wherein the third and fourth vibration manipulators are adapted to act upon the second shuttling mass.

12. The vehicle suspension structure set forth in claim 11, wherein the partition is fixed to the hollow structural component.

13. The vehicle suspension structure set forth in claim 11, wherein the partition is adapted to slide within the hollow structural component.

14. The vehicle suspension structure set forth in claim 4, wherein the first shuttling mass includes a friction reducing coating.

15. The vehicle suspension structure set forth in claim 7, wherein the TVA includes a third vibration manipulator, a fourth vibration manipulator and a second shuttling mass disposed between the third and fourth vibration manipulators, and wherein the second shuttling mass is disposed parallel to the first shuttling mass.

16. A lower control arm of a vehicle suspension structure defining an internal cavity extending along a centerline, the lower control arm comprising:
a Tuned Vibration Absorber (TVA) disposed in the cavity.

17. The lower control arm set forth in claim 16, wherein the TVA includes a first vibration manipulator, a second vibration manipulator, and a shuttling mass disposed axially between the first and second vibration manipulators.

18. The lower control arm set forth in claim 17, wherein the first and second vibration manipulators are made of a resiliently compressible rubber-like material.

19. The lower control arm set forth in claim 18, wherein the resiliently compressible rubber-like material is high temperature silicone.

20. The lower control arm set forth in claim 18, wherein the shuttling mass is encased in the resiliently compressible rubber-like material of the first and second vibration manipulators.
